(19) United States
(12) Patent Application Publication
(10) Pub. No.: US 2021/0402650 A1
(43) Pub. Date: Dec. 30, 2021

(54) METHOD OF MANUFACTURING FEEDSTOCK FROM RECYCLED-FIBERS

(71) Applicant: Fibrecycle Materials Corp., Toronto (CA)

(72) Inventors: Kazem FAYAZBAKHSH, Toronto (CA); Lawrence LESSARD, Outremont (CA)

(21) Appl. No.: 17/364,608

(22) Filed: Jun. 30, 2021

Related U.S. Application Data
(60) Provisional application No. 63/045,871, filed on Jun. 30, 2020.

(51) Int. Cl. B29B 15/10; B29B 17/02; B29B 9/14

(52) U.S. Cl. CPC B29B 15/105; B29B 9/14; B29B 17/0206

(57) ABSTRACT

A method of manufacturing a part, includes: obtaining recycled fibers; mixing the recycled fibers with a thermoplastic to obtain a fiber-reinforced intermediate; and manufacturing the part with the fiber-reinforced intermediate. The recycled fibers may come from a grinding operation of recycled composite parts. A feedstock may be manufactured using recycled fibers. The feedstock may then be used in subsequent manufacturing.

### CROSS-REFERENCE TO RELATED APPLICATIONS

The present application claims priority on U.S. Patent Application No. 63/045,871 filed Jun. 30, 2020, the entire contents of which are incorporated herein by reference.

### TECHNICAL FIELD

This disclosure relates generally to the recycling and reuse of composite materials, such as fiberglass and other fiber-reinforced materials.

### BACKGROUND

Composite products (e.g., fibers in epoxy) are increasingly used in many industries, and the significant quantities of such composite products being disposed of at the end of their useful life may lead to undesirable environmental impacts. Recent reports have revealed that the total global production of composites has exceeded 10 million tonnes per year, which, at the end of life, may require over 5 million cubic meters for disposal. Glass fiber reinforced polymers (GFRP) is one category that has 90% use in all composites currently produced. Aircrafts, automotive parts, pipes, and sports equipment are some examples of application sectors for GFRPs. Among GFRP products, wind turbine rotor blades serve as one of the major application sectors of GFRPs, which has undergone significant growth.

The wind energy industry, in particular, is one of the fastest-growing sectors for composite use. Fiber-reinforced composites are typically used in the manufacturing of light rotor blades for wind turbines. Considering the limited lifetime of turbine blades, a growing number of wind turbines will need to be decommissioned in the near future. Turbine blades are generally landfilled at their end-of-life, resulting in negative environmental impact.

In the case of certain composites, particles are combined with a resin system and optionally combined with fillers, binders or reinforcements to produce new cured solid composite products. Resins which require curing are thermoset and mostly liquid. This may increase manufacturing time, health/safety concerns, and processing complexity, and results in minimal improvement in final part properties. Hence, improvements are sought. Moreover, thermoset resins require a curing stage that often needs pressure and heat.

### SUMMARY OF THE INVENTION

In one aspect, there is provided a method of manufacturing a part, comprising: obtaining recycled fibers; mixing the recycled fibers with a thermoplastic to obtain a fiber-reinforced intermediate; and manufacturing the part with the fiber-reinforced intermediate.

In another aspect, there is provided a method of manufacturing a feedstock for subsequent manufacturing, comprising: obtaining recycled fibers; mixing the recycled fibers with a thermoplastic to obtain a fiber-reinforced intermediate; and pelletizing the fiber-reinforced intermediate to obtain fiber-reinforced pellets as the feedstock.

In still another aspect, there is provided a method of producing a feedstock for use in subsequent manufacturing, comprising: recycling a fiber-reinforced composite material by shredding and/or grinding the fiber-reinforced composite material to produce isolated recycled fibers; mixing the isolated recycled fibers with a thermoplastic resin to obtain a fiber-reinforced thermoplastic matrix; and forming the feedstock from the fiber-reinforced thermoplastic matrix.

In yet another aspect, there is provided a method of manufacturing a finished part using the feedstock as described above, comprising melting the feedstock to form a molten intermediate, solidifying the molten intermediate to form the finished part.

In certain aspects, a method of manufacturing fiber-enhanced recycled composite feedstock for advanced manufacturing, e.g. additive manufacturing, compression molding, etc., is disclosed herein, which enables low cycle time and without the need for curing. Thermoplastic matrix(s), reinforcement(s), fillers, and additives are used to manufacture composite thermoplastic filaments and pellets with highly oriented particles including recycled fiberglass from industrial waste.

A process is described herein for recycling plastics, fibers, and/or fiber reinforced composites and create fiber-enhanced thermoplastics feedstock for advanced manufacturing with low cycle time and without the need for curing. Herein, thermoplastic resins, which are solid, are used in an extrusion process. This may allow the resulting recycled composite feedstock to be used in advanced manufacturing techniques with very short manufacturing time, minimal health/safety concerns, simple processing techniques, and results in maximum improvement in final part properties.

Thermoplastic resins may be used without the need for a curing stage. Final parts may be manufactured by melting the recycled composite feedstock and cooling it down to the required shape. This way, cycle times of hours may be reduced to only minutes.

The process of the present disclosure may allow the manufacturing of recycled feedstock for advanced manufacturing, e.g. additive manufacturing, compression molding, etc., with low cycle time and without the need for curing, thermoplastic matrix(s), reinforcement(s), fillers, and additives are used.

This disclosure proposes a systematic scheme combining mechanical recycling and 3D printing to recycle the valuable constituents of the scrap blades and reuse them in a Fused Filament Fabrication (FFF) process with the aim of improving the mechanical performance of 3D printed components. Mechanical grinding integrated with a double sieving mechanism is utilized to recover the reinforcement fibers. Tensile test specimens with 5 wt % fiber content are fabricated from the recycled fibers and plastic pellets and their mechanical properties as well as internal microstructure are investigated. The results demonstrate an improvement of 16% and 10% in the elastic modulus and ultimate strength of the reinforced composite filament as compared to the commercially available pure PLA filament. As well, a Young's modulus of 3.35 GPa was observed for the FFF fabricated samples, which is an 8% increase relative to pure PLA samples.

Mechanical grinding may be used to as a recycling technique to recover fibers (e.g., glass fibers). Compared to thermal and chemical techniques, mechanical grinding method may offer a straightforward and economically feasible scheme for the recycling of composites, particularly glass fiber reinforced materials.

The present disclosure uses fiber glass scrap from wind turbine blades, or from any other suitable recycled part, as reinforcement in thermoplastic filaments for 3D printing to achieve the following: addressing the challenging issue of wind turbine blade scrap that is increasingly growing every year; and improving mechanical properties of 3D printed thermoplastic parts without the need of adding high cost virgin fibers. In this disclosure, the ASTM D638 standard test method, as published on Jun. 30, 2021, is followed to properly characterize tensile strength of 3D printed parts out of pure PLA and PLA reinforced with fiberglass. In the following sections, first, a systematic methodology is proposed integrating mechanical recycling and filament extrusion to manufacture PLA filaments reinforced with fiberglass. Then, specimen geometry, configuration, and testing procedure are described as per ASTM D638. Next, the specimen manufacturing, including 3D printing process and design parameters, is described extensively. Experimental testing is performed and the tensile strength for different filament materials is obtained. Finally, the performance of the 3D printed specimens with pure and reinforced PLA is discussed and recommendations for future research are presented.

Many further features and combinations thereof concerning the present improvements will appear to those skilled in the art following a reading of the instant disclosure.

### BRIEF DESCRIPTION OF THE DRAWINGS

FIG. 1 is a flow chart illustrating a method of manufacturing a part;

FIG. 2 is a flow chart illustrating a method of manufacturing a feedstock; and

FIG. 3 is a flow chart illustrating a method of producing a feedstock for use in subsequent manufacturing.

### DETAILED DESCRIPTION

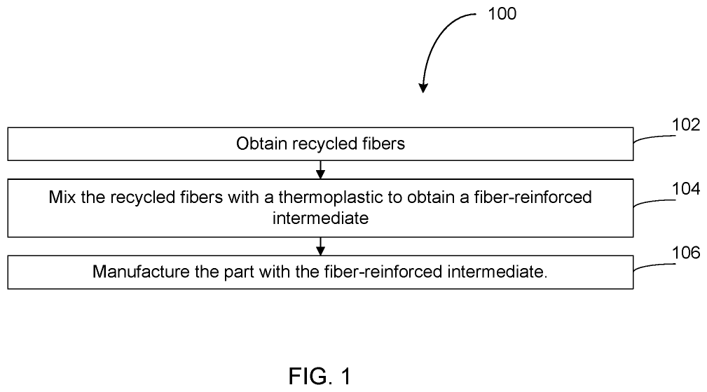

Referring to FIG. 1, a method of manufacturing a part is shown at 100. The method 100 includes obtaining recycled fibers at 102; mixing the recycled fibers with a thermoplastic to obtain a fiber-reinforced intermediate at 104; and manufacturing the part with the fiber-reinforced intermediate. The different steps are described in more detail below. The part may be manufactured using an additive manufacturing process (e.g. 3D printing). Any other suitable process, such as extrusion, compression molding, etc, may be used. The thermoplastic may be provided in the form of polylactic acid (PLA) pellets.

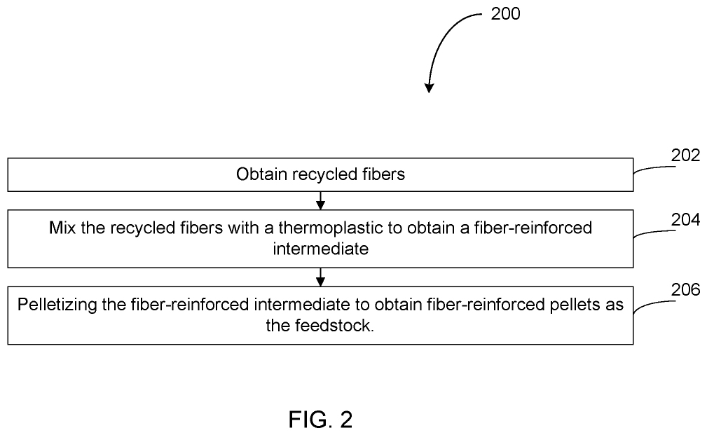

Referring to FIG. 2, a method of manufacturing a feedstock for subsequent manufacturing is shown at 200. The method 200 includes obtaining recycled fibers at 202; mixing the recycled fibers with a thermoplastic to obtain a fiber-reinforced intermediate at 204; and pelletizing the fiber-reinforced intermediate to obtain fiber-reinforced pellets as the feedstock at 206. These pellets may then be used at step 106 of the method 100 to produce a part.

The step of obtaining the recycled fibers 102 may include a mechanical recycling method combining grinding and a double sieving process is performed to recover the glass fibers from the scrap blades. Since the diameter of the 3D printer nozzle used here is 0.4 mm, the double sieving operation ensures a supply of fibers with a length generally below 0.4 mm, a characteristic essential for filaments with high processability.

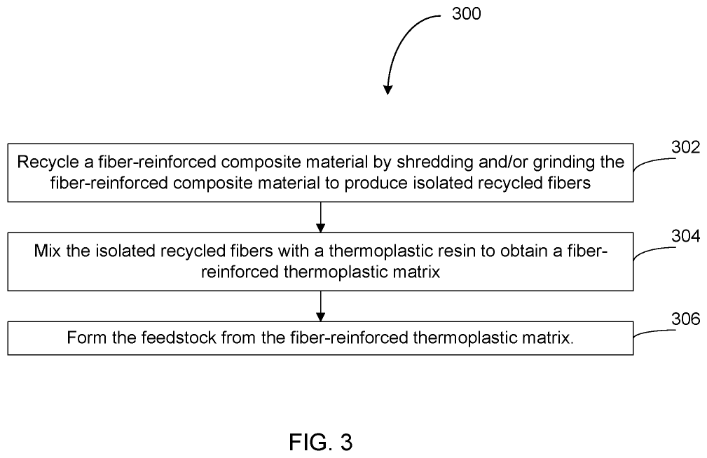

Referring to FIG. 3, a method of producing a feedstock for use in subsequent manufacturing is shown at 300. The method 300 includes recycling a fiber-reinforced composite material by shredding and/or grinding the fiber-reinforced composite material to produce isolated recycled fibers at 302; mixing the isolated recycled fibers with a thermoplastic resin to obtain a fiber-reinforced thermoplastic matrix at 304; and forming the feedstock from the fiber-reinforced thermoplastic matrix at 306.

To manufacture a finished part using the feedstock obtained from the method 300, the feedstock may be molten to form a molten intermediate. The molten intermediate may be solidified to form the finished part.

The mixture of the PLA pellets and the fibers may be placed in a dehydrator machine for a drying process of 4 hours at 60° C. This dehydrations process reduces the moisture content of the pellets that could generate voids during the extrusion process.

To generate the Recycled Glass Fiber Reinforced Filament (RGFRF) for Fused Filament Fabrication (FFF), the recycled fibers may be fed into a twin-screw extruder connected to a pelletizer to produce glass fiber reinforced pellets. Following the initial extrusion, the glass fiber reinforced pellets may be re-dried and fed into a single screw extruder to produce RGFRF. The extruder screw speed, the die temperature as well as the winder speed are tuned to attain a filament with consistent diameter of 1.75 mm.

### Grinding

Reducing particles size in the grinding stage to a specific dimension may require multiple grinding, which may increase time and cost. By reducing the particles size used in a recycled composite filament, it may be processed in additive manufacturing more easily. However, it should be noted that fiber length higher than the critical fiber length ensures maximum improvement in structural, thermal, or electrical performance. Lower and upper bounds for fiber length for PLA composite material reinforced by ground fiberglass may be 0.57 and 1.14 mm, respectively.

By reducing the particles size used in reinforced thermoplastic pellets, its processability using 3D printing may be improved. For example, for smaller fiber length, the possibility of discontinuous fibers forming an aggregate and clogging the nozzle in FFF 3D printing is reduced. In addition, for smaller fiber length, surface quality and dimensional accuracy of final 3D printed parts may be improved. However, it should be noted that fiber length higher than the critical fiber length ensures maximum improvement in structural, thermal, or electrical performance. In one embodiment, the lower bound for critical fiber length for PLA composite material reinforced by ground fiberglass from a wind turbine blade was obtained as 0.57 mm. In one embodiment, ground fiberglass with an average length of 0.15 mm (below the critical fiber length of 0.57 mm) was used as reinforcement in PLA pellets, while some fibers in another embodiment were above the critical fiber length. In one embodiment, a standard nozzle diameter of 0.4 mm was used for 3D printing and tensile specimens showed high surface quality with no defect. On the other hand, in another embodiment, a larger nozzle diameter of 1.2 needed to be used to prevent possible clogging and extrinsic defects were observed on the surface of tensile specimens. Considering tensile properties, only 8% improvement in Young's modulus and no meaningful increase in ultimate tensile strength compared with pure PLA specimens was observed for PLA reinforced with fibers below the critical fiber length. Conversely, experimental measurements showed an increase of 20% in specific tensile strength for PLA specimens reinforced with some fibers above the critical fiber length compared with pure PLA specimens.

End-of-life and/or scrap parts made of reinforced thermoplastic pellets, and reinforced thermoplastic pellets waste may be fed into the grinding stage again to make input for the pelletizer. The process explain above can be followed to make new reinforced thermoplastic pellets that can be used in advanced manufacturing. This creates a full circle recycling schedule that can be repeated multiple times.

Herein, recycled glass fibers with an average length of 0.1-0.4 mm are obtained from grinding a turbine blade, or any other suitable recycled composite part, made of glass fiber reinforced epoxy composite. Since the nozzle diameter of a printer used may be 0.4 mm, this range of fiber length may ensure a high processability for the proposed filament. A three-stage recycling procedure may be used here to obtain the fibers for the filament extrusion: first, the recycled parts are cut down into pieces (e.g., 20×20 cm) using a band saw or any other suitable tool and then fed into a grinder machine (e.g., ECO-WOLF, INC.) consisting of a hammer mill system and a classifier with a hole size of 3 mm. A double sieving mechanism may be used to further separate the fibers of varying lengths. Two grades of granulated material may be obtained. The granulated recycled parts obtained from the first grinding process is sieved through a stainless-steel screen with a hole size of 0.1 mm. The larger-sized recycled material is then re-fed in the sieve for the second sieving operation to extract more fine fibers that are in the desirable length range. Understandably, any suitable sieving mechanism and hole size may be used.

The thermal and mechanical recycling methods are used here to obtain glass fibers from end-of-life wind turbine blades or other composite parts. The scrap parts may be first cut into small 20 cm×20 cm pieces using a band saw. The pieces may then be ground using a hammer mill grinder (ECO-WOLF, INC.). To obtain fiber bundles with an appropriate length for single fiber tests, a screen classifier with a hole size of 19 mm is used.

The thermal recycling of the scrap parts (e.g., blade) is carried out after an initial granulation process. Following the grinding process, 100 g of the recyclate materials is placed in the pyrolysis furnace (F200 PYRADIA, Quebec, Canada) at 550° C. and retained for a total duration of 45 min. The pyrolysis process is performed in the presence of nitrogen followed by an oxidative stage at 550° C. for 10 min to remove the ash content left on the surface of the recovered fibers, as shown in FIG. 1D. Subsequently, individual fibers from fiber bundles of both mechanically and thermally recycled compounds are carefully separated and used for single fiber tensile and pull-out tests. For convenience, mechanically recycled fibers before pyrolysis and thermally recycled fibers after pyrolysis are hereafter referred to as ground fibers and pyrolyzed fibers, respectively.

### Extrusion

The screw speed, temperature profile, and winding speed in the extruder may be adjusted to minimize the residence time in the melt, and avoid polymer degradation. In some embodiments, the extruder is a FilaFab PRO 350 EX with a winder was used to make recycled composite filaments out of reinforced pellets. Optimum screw speed, die temperature, and winder speed may be 25 rpm, 210° C., and 1 rpm, respectively. Any other suitable extruder may be used.

In one embodiment, a ZSE181HP-40D twin-screw extruder twin-screw extruder with 8 subzones connected to a pelletizer to produce PLA pellets reinforced with fiberglass from a wind turbine blade. The optimum screw speed may be 80 rpm and the temperature in subzones were as follows: subzone 1-2: 190° C., subzone 3: 185° C., subzone 4: 180° C., subzone 5: 175° C., subzone 6-8: 170° C.

A double melt extrusion process of PLA pellets (Ingeo 4043D, Natureworks LLC, Blair, Nebr.) and 5 wt % recycled glass fibers may be used. PLA is a hygroscopic thermoplastic and readily absorbs moisture from the atmosphere. The presence of moisture may hydrolyze the biopolymer, which may result in void generation during the extrusion process. Furthermore, the presence of moisture on the surface of the fibers can form fiber clusters, which may prevent a homogeneous distribution of fibers within the polymer. As a preventative measure, a dehydration process on the fibers and the PLA pellets may be performed at 60° C. for 4 hours to dry the fibers and reduce the moisture content of the pellets to below 250 ppm.

Once the fibers and the pellets are dried, they may be fed into an extruder, which may be a twin-screw extruder (Leistritz ZSE18HP-40D, Nuremberg, Germany) with 8 subzones connected to a pelletizer to produce glass fiber reinforced pellets. This process may ensure a homogeneous distribution of the fibers within the matrix, which may be an essential factor to the dimensional accuracy of the filament, as well as the mechanical properties of the 3D printed components. The reinforced pellets are then re-dried and fed into a single screw extruder (FilaFab, D3D Innovations Limited, Bristol, UK) to produce RGFRF. To increase the dimensional accuracy of the filament, a spool winder machine may be connected to the extruder, which may allow for accurate control of the filament diameter. To consistently monitor the diameter of the filament, a laser micrometer with ±2 μm accuracy is used. The extrusion parameters including the screw speed, the speed of the winder as well as the die temperature are properly adjusted to achieve a 1.75±0.05 mm filament, a suitable diameter and tolerance for the 3D printing process. The screw speed and the temperature of each zone during the initial and the second extrusion processes are reported in Table 1. Scanning Electron Microscopy (Hitachi UHR Cold-Emission FE-SEM SU8000) and optical microscopy (Nikon, Tokyo, Japan) are used to characterize the microstructural features of the RGFRF namely, the fiber distribution and fiber orientation. The filament is sectioned transversely and longitudinally, where the former is used to monitor the fiber distribution and the latter shows the fiber orientation. For the longitudinal cross section, the samples are potted in an epoxy resin, ground and polished in preparation for the microstructural analysis. Grinding is done using 120 grit, followed by 220 and 600 grit sandpaper, and polishing is performed using a 10 μm diamond slurry, then a 5 μm diamond slurry, and finished with a 0.3 μm alumina suspension.

### Thermoplastic Matrix

The thermoplastic matrix may be virgin material in the form of pellets or can be the output of the grinding stage, where strands/pellets of recycled thermoplastics are obtained. Pure thermoplastic end-of-life parts, scrap parts, and materials waste are examples of the grinding stage input. Synthetic-based commodity plastic, e.g. PolyPropylene (PP), PolyStyrene (PS), PolyEthylene (PE), and PolyVinyl Chloride (PVC), and bioplastics, e.g. PolyLactic Acid (PLA), are examples of thermoplastic materials that can be used as matrix. In addition, engineering plastics, e.g. PolyEther Ether Ketone (PEEK) and polyamides, are other examples of thermoplastic materials that can be used as matrix.

One or multiple types of virgin or recycled thermoplastic pellets may be melted in a twin-screw extruder and reinforcements, fillers, and additives may be added using a twin-screw side stuffer to avoid early regions of the extruder with high shear stress. The resulting molten mixture may then be extruded through a die orifice, cooled down in air or a liquid, and wound to make feedstock filament for additive manufacturing with custom modified physical, structural, thermal, and/or electrical properties. The filament diameters may be 1.75, 2.85 mm or any other custom size.

The resulting molten mixture is then cooled down in air or a liquid and is cut to a prescribed size. The result is reinforced thermoplastic pellets or strands with modified physical, structural, thermal, electrical, and/or specialized properties. They can be used as feedstock for advanced manufacturing techniques. Examples include pellet extrusion for additive manufacturing, compression molding and injection molding.

These reinforced thermoplastic pellets can be used to manufacture large-scale parts using advanced manufacturing techniques, e.g. compression molding, injection molding, and pellet extrusion 3D printing. Final parts out of reinforced thermoplastic pellets have higher structural (e.g. strength), thermal (e.g. thermal insulation), and electrical properties (e.g. electrical conductivity), and have modified physical (e.g. color) and specialized properties (UV resistance) compared with parts made of pure thermoplastic pellets. These properties make reinforced thermoplastic pellets interesting for manufacturing large-scale parts, e.g. a camp trailer, buildings, or construction components.

### Reinforcement Fibers

Reinforcement can be virgin fibers, e.g. carbon and glass fibers, or can be the output of the grinding stage, where strands of recycled fibers or recycled fiber reinforced composites are obtained. Pure fibers from materials waste is an example of the grinding stage input. Fiber reinforced composites with thermosets or thermoplastics as end-of-life parts, scrap parts, and materials waste are examples of the grinding stage input. End-of-life parts include any manufactured fiber reinforced composite parts that were in operation and reached their end-of-life. Scrap parts include any manufactured fiber reinforced composite that did not meet specified requirements and did not enter operation. Materials waste include raw fiber-reinforced composite materials that were not used in manufacturing composite parts because among other reasons they expired (e.g. for thermoset prepregs) or were not in proper size (e.g. leftovers from prepreg cutting and nesting) or did not meet specific requirements (e.g. not meeting storage requirements for thermoplastic prepregs).

### Fillers

Fillers include inorganic and organic materials, e.g. silica, silicon carbide, Magnesium hydroxide, aluminum oxide, zinc oxide, wood, and rocks. They can be virgin materials or the output of the grinding stage, where pellets of fillers are obtained. The methods 100, 200 may include adding fillers to the mix.

In one embodiment, the fillers, the pure fibers, or the recycled fiber reinforced composites from the grinding stage may be less than 0.4 mm (0.0157″) in length, so the resulting feedstock filament may be suitable for additive manufacturing. Other lengths are contemplated for other uses. In another embodiment, the fillers, the pure fibers, or the recycled fiber reinforced composites from the grinding stage may be less than 1.2 mm (0.0472″) in length, so the resulting feedstock filament is suitable for additive manufacturing. In another embodiment, the fillers, the fillers, the pure fibers, or the recycled fiber reinforced composites from the grinding stage may be less than 3.175 mm (0.125″) in length, so the resulting feedstock filament is suitable for additive manufacturing. In another embodiment, the fillers, the fillers, the pure fibers, or the recycled fiber reinforced composites from the grinding stage may be larger than 3.175 mm (0.125″) in length and the resulting feedstock filament is used for additive manufacturing.

In one embodiment, the fillers, the pure fibers, or the recycled fiber reinforced composites from the grinding stage should be less than 1 mm (0.0394″) in length, so the resulting reinforced thermoplastic pellets may be suitable for pellet extrusion 3D printing, e.g. using Pulsar pellet extruder from Dyzedesign. In another embodiment, the fillers, the pure fibers, or the recycled fiber reinforced composites from the grinding stage are be less than 2 mm (0.0787″) in length, so the resulting reinforced thermoplastic pellets may be suitable for pellet extrusion 3D printing, e.g. using Pulsar pellet extruder from Dyzedesign. In another embodiment, the fillers, the fillers, the pure fibers, or the recycled fiber reinforced composites from the grinding stage are less than 3.175 mm (0.125″) in length, so the resulting reinforced thermoplastic pellets may be suitable for pellet extrusion 3D printing, e.g. using Pulsar pellet extruder from Dyzedesign. In another embodiment, the fillers, the fillers, the pure fibers, or the recycled fiber reinforced composites from the grinding stage are more than 3.175 mm (0.125″) in length, so the resulting reinforced thermoplastic pellets may be used with pellet extruders for 3D printing with a diameter more than 3.175 mm (0.125″).

Larger fillers, the pure fibers, or the recycled fiber reinforced composites from the initial grinding stage can be passed through the grinding stage again to obtain particles in the specified ranges above. This process can be repeated multiple times until all items are within desirable ranges.

In another embodiment, after passing material through the grinding stage for one or multiple times, larger particles are considered either waste or fiber-enhancement to other industrial materials processes such as concrete. Multiple studies have shown that the surface of ground glass fibers from wind turbine blades is covered with residue epoxy particles [3-5]. Epoxies have excellent chemical resistance and can withstand the alkaline environment of concrete. Currently, in reinforced concrete application, glass fibers need to be treated to become alkali-resistant, which increases cost and time.

### Additives

Additives include pigments & colorants, fire retardants, suppressants, UV inhibitors & stabilizers, electrically conductive additives, thermal conductive additives. They can be virgin materials in the form of pellets.

### Proportions

The fillers, the pure fibers, the recycled fiber reinforced composites, and the additives may be added to the thermoplastic matrix in different content by weight percentage to achieve desirable mechanical, thermal, or electrical properties. In some embodiments, reinforced PLA filaments with 25% ground fiberglass content by weight and an average 0.19 mm fiber length were manufactured as feedstock for additive manufacturing. Final parts manufactured using Fused Filament Fabrication (FFF) technique showed 74% improvement in specific stiffness (2.56 GP·cm3/gr to 4.45 GP·cm3/gr) compared with parts made using the pure thermoplastic PLA filaments.

The content amount of fillers, pure fibers, the recycled fiber reinforced composites, and additives in the extrusion impacts the particles length in the resulting recycled composite filament. In one embodiment, increasing fiberglass content, obtained from grinding a wind turbine blade, from 3 to 5, and 10 wt % may adversely affect the fiber length distribution by reducing the mean fiber length from 0.55 to 0.35, and 0.30 mm.

There may be a maximum content for the fillers, the pure fibers, the recycled fiber reinforced composites, and additives that may be added to a thermoplastic resin to make feedstock filaments for additive manufacturing with higher performance than pure thermoplastic filament. This may depend on the particle size used in the extrusion and the specific property desired for the application.

In ground fiber reinforced composites, fibers are covered in matrix residue. To make reinforced filament with ground fiber reinforced composites as feedstock for additive manufacturing, compatibility between the matrices may be important. The right combination may even eliminate the need for removing matrix residue of fibers in the ground fiber reinforced composites before its use in the feedstock filaments. This may prevent the need for recycling techniques that are costly and have negative environmental impact, e.g., combustion with energy recovery, fluidised bed processes, and pyrolysis. PLA filaments reinforced with 10 wt % virgin and ground fiberglass, with an average fiber length of approximately 0.19 mm, were manufactured as feedstock for additive manufacturing. Parts fabricated out of PLA filaments reinforced with ground fiberglass showed higher specific strength and stiffness, with values 19% and 8% higher than those of specimens reinforced with virgin fibers.

End-of-life and/or scrap parts made of reinforced composite filaments, and reinforced filaments waste may be fed into the grinding stage again to make input for the filament maker. The process explained above can be followed to make new reinforced thermoplastic filaments that can be used in additive manufacturing. This creates a full circle recycling schedule that can be repeated multiple times.

Liquid thermoset resins may increase health/safety concerns with composites manufacturing. For example, in open mold applications, styrene emission happens during mixing and curing of liquid thermoset resins that should be blocked for air quality compliance. On the other hand, thermoplastic resins are solid materials that introduce minimum health/safety concerns compared with liquid thermoset resin.

The disclosed process may result in recycled composite feedstock for advanced manufacturing. The feedstock may not have a shelf life, may not expire, and may be stored indefinitely. It may be used in additive manufacturing to make complex parts without the need for a form or a mold.

In the disclosed process, thermoplastic resins are melted in a twin-screw extruder and particles are added. The resulting molten mixture is then extruded through a die orifice that may align particles in the extrusion direction. The particles, e.g. fibers, in the recycled composite feedstock may be highly oriented along one direction. Recycled composite filament reinforced with 10 wt % fiberglass content from a wind turbine blade was manufactured. Micro computed tomography (μCT) was used to capture the orientation of the fibers within the extruded feedstock. Representative samples from the composite filaments were extracted and scanned at a resolution of 3 um. Results showed fibers were highly aligned along the reinforced filament length.

The parts manufactured with additive manufacturing using the fiber-reinforces filaments revealed an increase in the elastic modulus and strength in the reinforced composite filament. All samples showed higher specific stiffness compared to neat PLA samples. Specimens with recycled glass fibre length of 0.38 mm and 5% fibre content showed an increase in both specific stiffness and strength of, respectively, 28 and 20% compared to the pure PLA specimens.

### REFERENCES

Each of the following references is incorporated herein by reference in its entirety.
Recycled composite materials and related methods, US 2011/0301287A1,
Rahimizadeh, A., Kalman, J., Fayazbakhsh, K., Lessard, L. (2019) Recycling of fiberglass wind turbine blades into reinforced filaments for use in additive manufacturing. Composites Part B: Engineering 175, 107101.
Rahimizadeh, A., Fayazbakhsh, K., Lessard, L. (2020) Tensile properties and interface strength of reclaimed fibers from recycled fiberglass wind turbine blades, Composites Part A, 131, 105786.
Rahimizadeh, A., Kalman, J., Henri, R., Fayazbakhsh, K., Lessard, L. (2019) Recycled glass fiber composites from wind turbine waste for 3D printing feedstock: effects of fiber content and interface on mechanical performance. Materials, 12 (23), 3929.
Amirmohammad Rahimizadeh, Jordan Kalman, Kazem Fayazbakhsh, Larry Lessard, Recycling of fiberglass wind turbine blades into reinforced filaments for use in Additive Manufacturing, Composites Part B: Engineering, Volume 175, 2019, 107101, ISSN 1359-8368, https://doi.org/10.1016/j.compositesb.2019.107101.
Rahimizadeh, A.; Kalman, J.; Henri, R.; Fayazbakhsh, K.; Lessard, L. Recycled Glass Fiber Composites from Wind Turbine Waste for 3D Printing Feedstock: Effects of Fiber Content and Interface on Mechanical Performance. Materials 2019, 12, 3929. https://doi.org/10.3390/ma12233929
Amirmohammad Rahimizadeh, Mazin Tahir, Kazem Fayazbakhsh, Larry Lessard, Tensile properties and interfacial shear strength of recycled fibers from wind turbine waste, Composites Part A: Applied Science and Manufacturing, Volume 131, 2020, 105786, ISSN 1359-835X, https://doi.om/10.1016/j.compositesa.2020.105786.
Rahimizadeh, A, Kalman, J, Fayazbakhsh, K, Lessard, L. Mechanical and thermal study of 3D printing composite filaments from wind turbine waste. Polymer Composites. 2021; 42: 2305-2316. https://doi.org/10.1002/pc.25978
Tahir, M., Rahimizadeh, A., Kalman, J., Fayazbakhsh, K., Lessard, L., Polymer Composites 2021, 1. https://doi.org/10.1002/pc.26166

As can be seen therefore, the examples described above and illustrated are intended to be exemplary only. The scope is indicated by the appended claims.

What is claimed is:

1. A method of manufacturing a part, comprising:
obtaining recycled fibers;
mixing the recycled fibers with a thermoplastic to obtain a fiber-reinforced intermediate; and
manufacturing the part with the fiber-reinforced intermediate.

2. A method of manufacturing a feedstock for subsequent manufacturing, comprising:
obtaining recycled fibers;
mixing the recycled fibers with a thermoplastic to obtain a fiber-reinforced intermediate; and
pelletizing the fiber-reinforced intermediate to obtain fiber-reinforced pellets as the feedstock.

3. A method of producing a feedstock for use in subsequent manufacturing, comprising:
recycling a fiber-reinforced composite material by shredding and/or grinding the fiber-reinforced composite material to produce isolated recycled fibers;
mixing the isolated recycled fibers with a thermoplastic resin to obtain a fiber-reinforced thermoplastic matrix; and
forming the feedstock from the fiber-reinforced thermoplastic matrix.

4. A method of manufacturing a finished part using the feedstock of claim 3, comprising melting the feedstock to form a molten intermediate, solidifying the molten intermediate to form the finished part.
